(19) United States
(12) Patent Application Publication
(10) Pub. No.: US 2023/0255233 A1
(43) Pub. Date: Aug. 17, 2023

(54) COMBINATION OF HEMP PROTEIN AND MUSHROOMS

(71) Applicant: Walid Abboud, Miami, FL (US)

(72) Inventor: Walid Abboud, Miami, FL (US)

(21) Appl. No.: 18/101,598

(22) Filed: Jan. 26, 2023

Related U.S. Application Data
(60) Provisional application No. 63/310,164, filed on Feb. 15, 2022.

(51) Int. Cl. A23J 1/00; A23J 1/20; A23L 27/10

(52) U.S. Cl. CPC A23J 1/007; A23J 1/205; A23L 27/10

(57) ABSTRACT

A combination of hemp protein, or whey protein, or whey isolate protein, or pea protein, and mushrooms to increase the health and wellbeing of a person ingesting the combination.

### CROSS-REFERENCE TO RELATED APPLICATION

The present application is related to and claims priority from prior provisional application Ser. No. 63/310,164, filed Feb. 15, 2022, which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to the combination of hemp protein, or whey protein, or whey isolate protein, or pea protein, and mushrooms for ingestion and resulting health benefits.

### 2. Description of the Related Art

Prior art recipes using hemp protein, or whey protein, or whey isolate protein, or pea protein, do not combine with mushrooms. Furthermore, prior art mushroom recipes do not combine with hemp protein, or whey protein, or whey isolate protein, or pea protein. Therefore, the benefits of the combination of hemp protein, or whey protein, or whey isolate protein, or pea protein, and mushrooms for ingestion and health benefits, as described below, does not exist. Thus, a recipe including the combination of hemp protein, or whey protein, or whey isolate protein, or pea protein, and mushrooms to increase the health and wellbeing of a person ingesting the combination is a desired improvement.

### BRIEF SUMMARY OF THE INVENTION

In view of the foregoing disadvantages inherent in the known types of recipes incorporating hemp protein and mushrooms or the like in the prior art, the present invention provides a novel combination of hemp protein, or whey protein, or whey isolate protein, or pea protein, and mushrooms. As such, the general purpose of the present invention, which will be described subsequently in greater detail, is to provide a combination of hemp protein, or whey protein, or whey isolate protein, or pea protein, and mushrooms to increase the health and wellbeing of a person ingesting the combination, with all the advantages of the prior art and none of the disadvantages.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a view illustrating a recipe including the combination of hemp protein and mushrooms in a vanilla flavor according to an embodiment of the present invention.

FIG. 2 shows a view illustrating a recipe including the combination of hemp protein and mushrooms in a chocolate flavor according to an embodiment of the present invention.

FIG. 3 shows a flow chart.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

As discussed above, embodiments of the present invention relate to a combination of hemp protein, or whey protein, or whey isolate protein, or pea protein, and mushrooms to increase the health and wellbeing of a person ingesting the combination.

Prior art use of hemp protein was created by de-shelling the seeds of the hemp plant and grinding down the shell to extract hemp protein therefrom. This protein was very bitter to the taste and had an undesirable texture and color for use in recipes and for ingestion. The instant combination and resulting recipes uses the “heart” of the hemp plant seed. In other words, when the seeds are de-shelled the instant invention uses the “inside” of the seed, called “hemp hearts”, and discards the shells. The hemp hearts are then ground down into protein powder. The instant hemp protein powder is then combined with chosen elements and ingredients for the desired health benefits, for example different types of mushrooms.

Other elements and ingredients for combining with the instant hemp protein 306 includes Baobab (tree) pulp powder, which is considered a “super fruit” that includes vitamins, minerals, antioxidants, 50% fiber, potassium, calcium, magnesium; ASTRAGIN resulting in improved gut functions and includes PANAX, which is a microbiota (ie., notoginseng and Astragalus membranaceus); olive oil compounds including 50% olive oil on acacia (featuring Cobram Estate); “goFAT”, which is a registered trademark, having low carb fat powders including CLA (Conjugated Linoleic Acid), coconut, macadamia, COBRAM ESTATE extra virgin olive oil, which promotes maintaining blood sugar level, improves taste and texture of products, which helps improve health and the performance of individuals; protein isolates; and plant based proteins, minerals, antioxidants, unsaturated fats, and fiber.

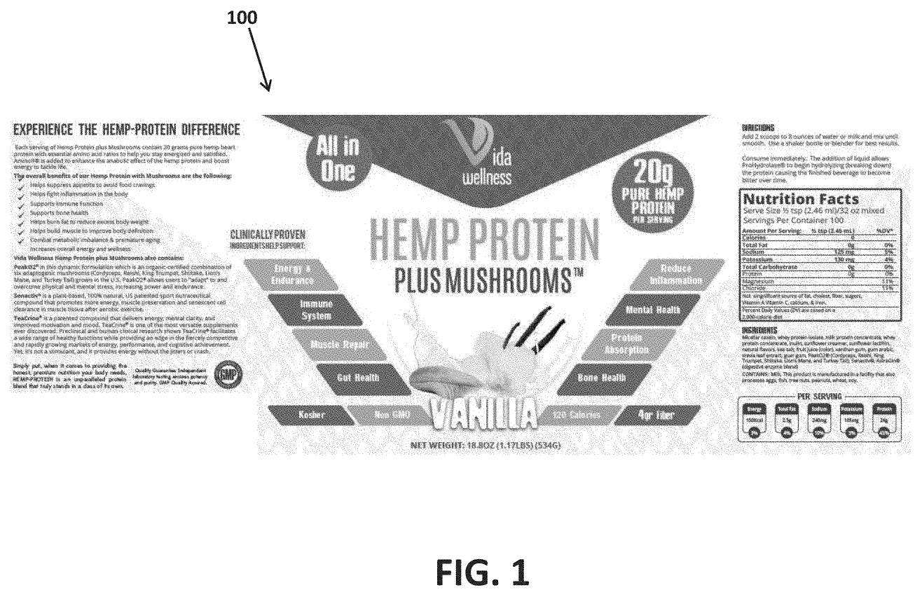

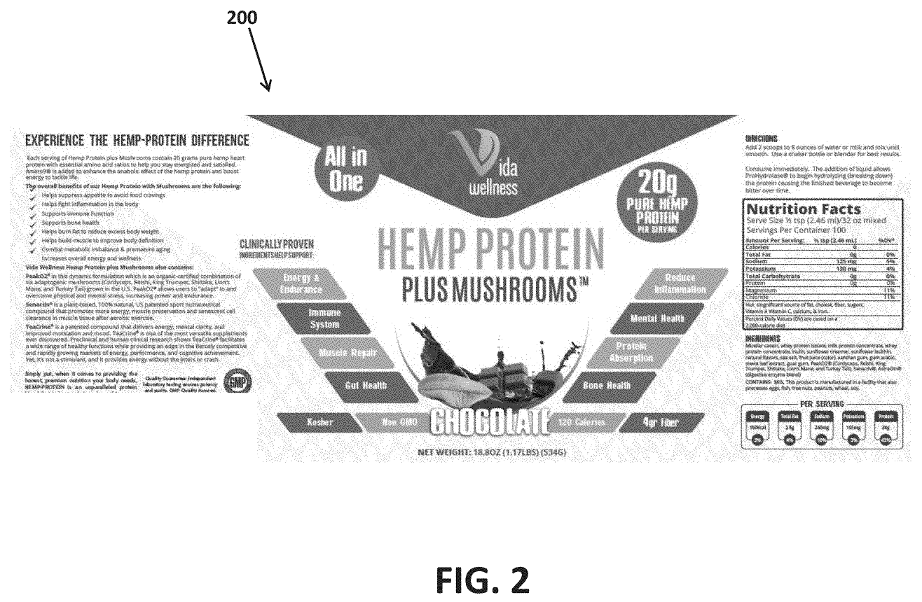

Referring now to the drawings FIGS. 1 and 2, the combination 100 and 200 respectively of hemp protein and mushrooms includes:

PeakO2®, which in this dynamic formulation which is an organic-certified combination of six adaptogenic mushrooms (Cordyceps, Reishi, King′Trumpet, Shiitake, Lion's Mane, and Turkey Tail) grown in the U.S. PeakO2® allows users to “adapt” to and overcome physical and mental stress, increasing power and endurance;

Senactiv®, which is a plant-based, 100% natural, US patented sport nutraceutical compound that promotes more energy, muscle preservation and senescent cell clearance in muscle tissue after aerobic exercise.

TeaCrine®, which is a compound that delivers energy, mental clarity, and improved motivation and mood. TeaCrine® is one of the most versatile supplements ever discovered. Preclinical and human clinical research shows TeaCrine® facilitates a wide range of healthy functions while providing an edge in the fiercely competitive and rapidly growing markets of energy, performance; and cognitive achievement. Yet, it's not a stimulant; and it provides energy without the jitters or crash.

Each serving of Hemp Protein plus Mushrooms contain 20 grams pure hemp heart protein with essential amino acid ratios to help you stay energized and satisfied. Amino9® is added to enhance the anabolic effect of the hemp protein and boost energy to tackle life. The overall benefits of our Hemp Protein with Mushrooms are the following:
Helps suppress appetite to avoid food cravings;
Helps fight inflammation in the body;
Supports immune Function;
Supports bone health;
Helps burn fat to reduce excess body weight;
Helps build muscle to improve body definition;
Combat metabolic imbalance & premature aging; and
Increases overall energy and wellness

The instant combination of hemp protein and mushrooms can be combined with CBD. Furthermore, the combination of hemp protein and mushrooms can be combined with protein bars and drinks, with peanut butter and/or chocolate, and/or combined with chocolate or vanilla flavorings.

The ingredients of the combination of hemp protein and mushrooms comprises micellar casein, whey protein isolate, milk protein concentrate, whey protein concentrate, inulin, sunflower creamer, sunflower lecithin, natural flavors, sea salt, fruit juice (color), xanthan gum, gum arabic, stevia leaf extract, guar gum, PeakO2® (Cordyceps, Reishi, King Trumpet, Shiitake, Lion's Mane, and Turkey Tail), Senactiv®, AstraGin® (digestive enzyme blend). The combination may further include milk, processed eggs, fish, tree nuts, peanuts, wheat, and soy.

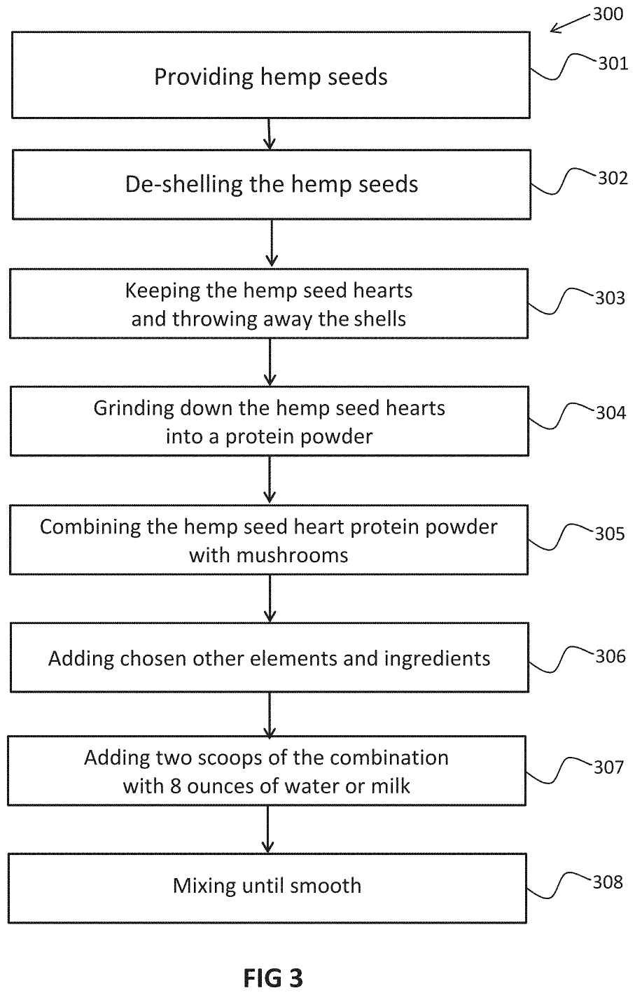

As shown within the flowchart of FIG. 3, the process of making and providing 300 the instant combination of hemp protein and mushrooms includes providing hemp seeds 301, de-shelling the hemp seeds 302, such that the instant combination uses the “inside” of the seed, called “hemp hearts”, and discards the shells 303. The hemp hearts are then ground down into protein powder 304. The instant hemp protein powder is then combined 305 with chosen elements and ingredients for the desired health benefits, for example different types of mushrooms.

Directions for use of the combination of hemp protein and mushrooms include adding 2 scoops to 8 ounces of water or milk 307 and mixing until smooth 308. Use a shaker bottle or blender for best results, and consuming immediately thereafter. The addition of liquid allows ProHydrolase® to begin hydrolyzing (breaking down) the protein causing the finished beverage to become bitter over time.

The combination of proteins and mushrooms may also include the use of whey protein, or whey isolate protein, or pea protein, or any type of protein, and mushrooms for ingestion and resulting health benefits. It should also be noted that adaptogens present in plants and mushrooms are also an ingredient that can become a part of the instant combination.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A recipe comprising the combination of:
protein; and
mushrooms;
wherein said combination is mixed together for consumption; and
wherein said combination is adapted to be ingested for the wellbeing of a person ingesting said combination.

2. The recipe of claim 1, wherein said protein is hemp protein.

3. The recipe of claim 1, wherein said protein is whey protein.

4. The recipe of claim 1, wherein said protein is whey isolate protein.

5. The recipe of claim 1, wherein said protein is pea protein.

6. The recipe of claim 1, wherein said protein is soy protein.

7. The recipe of claim 1, wherein said protein is milk protein.

8. The recipe of claim 1, further comprising chocolate flavoring.

9. The recipe of claim 1, further comprising vanilla flavoring.

10. The recipe of claim 1, further comprising milk.

11. The recipe of claim 1, further comprising water.

12. The recipe of claim 1, further comprising cannabidiol.

13. The recipe of claim 1, further comprising peanut butter.

14. The recipe of claim 2, wherein said hemp protein is formed from the inner hearts of hemp plant seeds.

15. The recipe of claim 1, further comprising tree pulp powder.

16. The recipe of claim 1, further comprising olive oil compounds.

17. The recipe of claim 1, further comprising coconut.

18. The recipe of claim 1, further comprising plant based unsaturated fat.

19. The recipe of claim 1, further comprising plant based fiber.

20. The recipe of claim 1, further comprising egg.
